(19) United States
(12) Patent Application Publication
(10) Pub. No.: US 2008/0288509 A1
(43) Pub. Date: Nov. 20, 2008

(54) DUPLICATE CONTENT SEARCH

(75) Inventors: Clarence Christopher Mysen, Santa Clara, CA (US); Johnny Chen, Mountain View, CA (US)

Correspondence Address: HARRITY & HARRITY, LLP, 11350 Random Hills Road, SUITE 600, FAIRFAX, VA, 22030, US

(73) Assignee: GOOGLE INC., Mountain View, CA (US)

(21) Appl. No.: 11/749,561

(22) Filed: May 16, 2007

(51) Int. Cl. G06F 17/30

(52) U.S. Cl. 707/100; 707/E17.108

(57) ABSTRACT

A system may store information regarding a set of items of content, receive sample content from a user, determine whether the sample content matches content of one or more of the items of content, and notify the user whether the sample content matches one or more of the items of content without identifying the one or more items of content to the user.

### BACKGROUND

The World Wide Web (“web”) contains a vast amount of information. Locating a desired portion of the information, however, can be challenging. This problem is compounded because the amount of information on the web and the number of new users inexperienced at web searching are growing rapidly. Search engines assist users in locating desired portions of this information by cataloging web pages. Typically, in response to a user's request, the search engine returns references to documents relevant to the request.

### SUMMARY

According to one aspect, a system may include a database and a duplicate content search unit. The database may store information regarding items of content uploaded or identified by a group of first users. The duplicate content search unit may receive sample content from a second user, determine whether the sample content matches one or more of the items of content, and notify the second user whether the sample content matches one or more of the items of content without identifying the one or more items of content to the second user.

According to another aspect, a system may include means for storing information regarding a group of items of content; means for receiving sample content from a user; means for determining whether the sample content matches one or more of the items of content; and means for notifying the user whether the sample content matches one or more of the items of content without identifying the one or more items of content to the user.

According to a further aspect, a method may include storing information regarding items of content uploaded or identified by a group of first users; receiving sample content from a second user; determining whether at least a threshold amount of the sample content is received; determining whether the sample content matches one or more of the items of content when at least the threshold amount of the sample content is received; and notifying the second user whether the sample content matches one or more of the items of content.

### BRIEF DESCRIPTION OF THE DRAWINGS

The accompanying drawings, which are incorporated in and constitute a part of this specification, illustrate one or more embodiments described herein and, together with the description, explain these embodiments. In the drawings,

FIG. 1 is a diagram of an overview of an exemplary implementation described herein;

FIG. 2 is an exemplary diagram of a network in which systems and methods described herein may be implemented;

FIG. 3 is an exemplary diagram of the content searching system of FIG. 2;

FIG. 4 is an exemplary diagram of the web content search unit of FIG. 3;

FIG. 5 is an exemplary diagram of the custom content search unit of FIG. 3;

FIG. 6 is an exemplary diagram of the database of FIG. 3;

FIG. 7 is an exemplary diagram of the duplicate content search unit of FIG. 3;

FIG. 8 is a flowchart of an exemplary process for providing information regarding the unauthorized use of content; and

FIG. 9 is a diagram of an example for providing information regarding the unauthorized use of content.

### DETAILED DESCRIPTION

The following detailed description refers to the accompanying drawings. The same reference numbers in different drawings may identify the same or similar elements. Also, the following detailed description does not limit the invention.

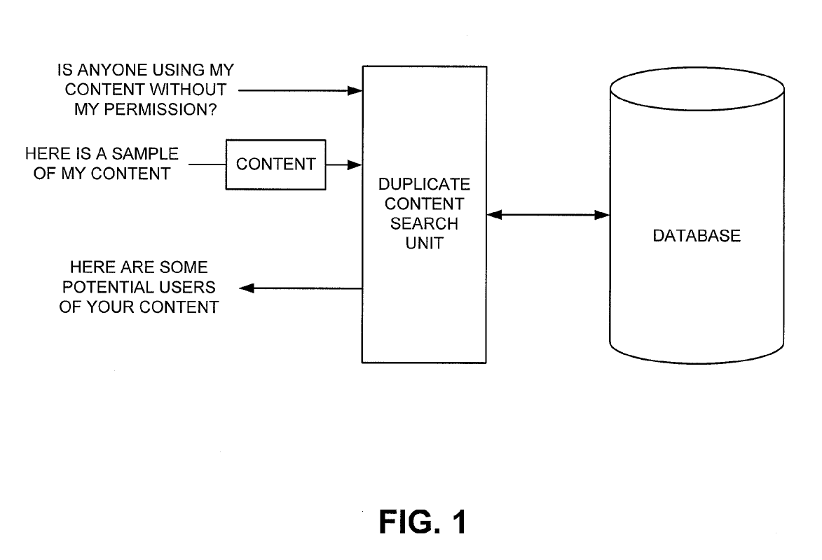

Implementations described herein may permit a content owner to determine whether someone else is using the content owner's content without the content owner's permission. FIG. 1 is a diagram of an overview of an exemplary implementation described herein. As shown in FIG. 1, a content owner may inquire of a duplicate content search unit whether anyone else is using the content owner's content without the content owner's permission. The content owner may provide a sample of the content owner's content to the duplicate content search unit. The duplicate content search unit may search a database containing content of other users to determine whether any of this content matches the content owner's content. The duplicate content search unit may provide the content owner with a list of some potential users of the content owner's content. The content owner may then take appropriate action to investigate and/or stop this unauthorized use.

“Content,” as the term is used herein, is to be broadly interpreted to include data that may or may not be in document form. Examples of content may include data associated with one or more documents, or data in one or more databases. A “document,” as the term is used herein, is to be broadly interpreted to include any machine-readable and machine-storable work product. A document may include, for example, an e-mail, a website, a business listing, a file, a combination of files, one or more files with embedded links to other files, a news group posting, a blog, an advertisement, etc. In the context of the Internet, a common document is a web page. Documents often include textual information and may include embedded information (such as meta information, image data, video data, audio data, hyperlinks to text, image data, video data, audio data, or other documents, etc.) and/or embedded instructions (such as Javascript, etc.).

“Custom content,” as that phrase is used herein, is to be broadly interpreted to include content that has been uploaded by a user for indexing and/or content identified by a user for indexing. A “user,” as that term is used herein, is to be broadly interpreted to include one or more people (e.g., a person, a group of people that may have some relationship (e.g., people associated with a business or organization), or a group of people with no formal relationship).

As used herein, “a match” may refer to a degree of similarity that is more than a threshold percentage of the content (i.e., a near-exact match), including a match of one hundred percent of the content (i.e., an exact match).

### Exemplary Network Configuration

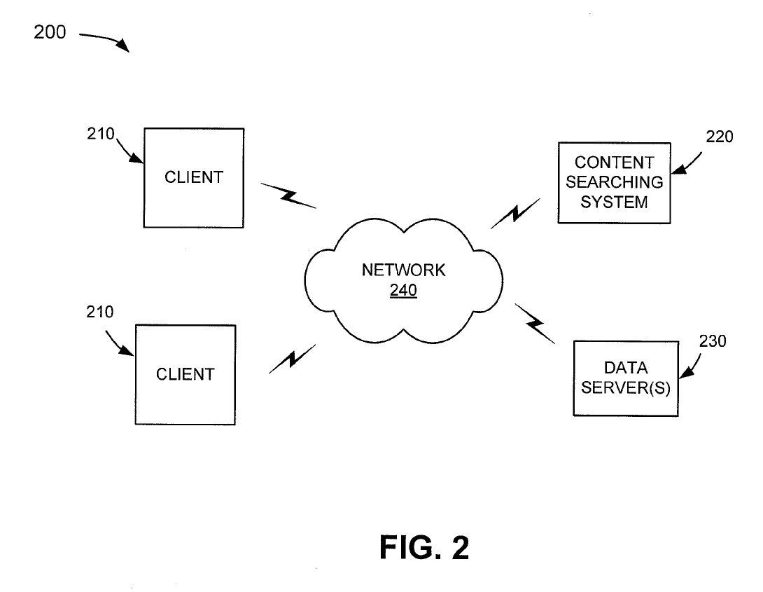

FIG. 2 is an exemplary diagram of a network 200 in which systems and methods described herein may be implemented. Network 200 may include multiple clients 210 connected to a content searching system 220 and data server(s) 230 via a network 240. Two clients 210, a single content searching system 220, and one or more data server(s) 230 have been illustrated as connected to network 240 for simplicity. In practice, there may be more or fewer clients, content searching systems, and data servers. Also, in some instances, a client 210 may perform one or more functions of content searching system 220 or server(s) 230, and/or content searching system 220 or a server 230 may perform one or more functions of a client 210.

Clients 210 may include client entities. An entity may be defined as a device, such as a personal computer, a wireless telephone, a personal digital assistant (PDA), a laptop, or another type of computation or communication device, a thread or process running on one of these devices, and/or an object executable by one of these devices. Clients 210 may implement a browser for browsing documents stored at data server(s) 230. Clients 210 may also use the browser for accessing content searching system 220 to search documents (e.g., web content) associated with data server(s) 230 and/or custom content, as described further below.

Data server(s) 230 may include server entities that may store or maintain documents that may be browsed by clients 210, or may be crawled by content searching system 220. Such documents may include data related to published news stories, products, images, user groups, geographic areas, or any other type of data. For example, data server(s) 230 may store or maintain news stories from any type of news source, such as, for example, the Washington Post, the New York Times, Time magazine, or Newsweek. As another example, server(s) 230 may store or maintain data related to specific products, such as product data provided by one or more product manufacturers. As yet another example, server(s) 230 may store or maintain data related to other types of web documents, such as pages of web sites (e.g., web content).

Content searching system 220 may include one or more hardware and/or software components that access, fetch, index, search, and/or maintain general web documents and/or custom content documents. Content searching system 220 may implement a data aggregation service by crawling a corpus of documents (e.g., web pages) hosted on data server(s) 230, indexing the documents, and storing information associated with these documents in a repository of crawled documents. The aggregation service may be implemented in other ways, such as by agreement with the operator(s) of data server(s) 230 to distribute their documents via the data aggregation service.

While content searching system 220 and server(s) 230 are shown as separate entities, it may be possible for content searching system 220 to perform one or more of the functions of one or more of servers 230, and vice versa. For example, it may be possible for content searching system 220 and one or more of servers 230 to be implemented as a single entity. It may also be possible for a single one of content searching system 220 or server(s) 230 to be implemented as two or more separate (and possibly distributed) devices.

Network 240 may include one or more networks of any type, including a local area network (LAN), a wide area network (WAN), a metropolitan area network (MAN), a telephone network, such as the Public Switched Telephone Network (PSTN) or a cellular network, an intranet, the Internet, or a combination of networks. Clients 210, content searching system 220, and server(s) 230 may connect to network 240 via wired and/or wireless connections.

### Exemplary Content Searching System

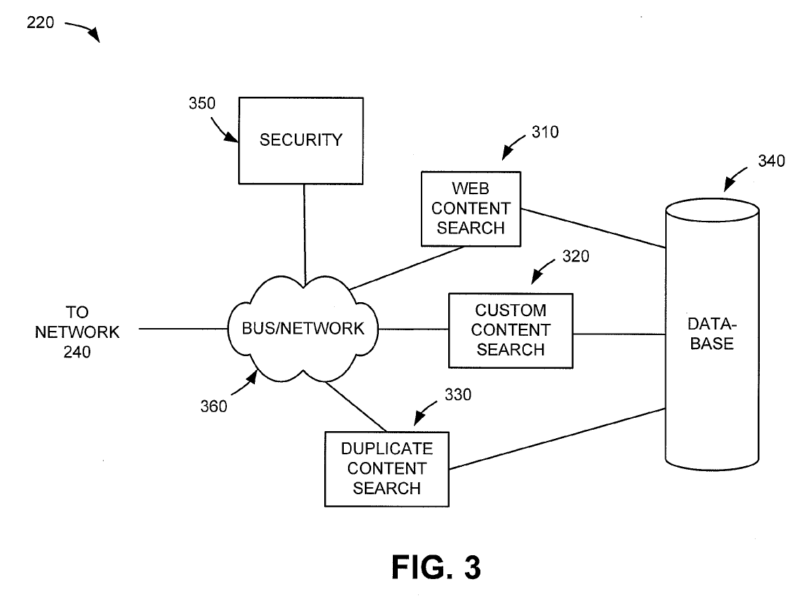

FIG. 3 is an exemplary diagram of content searching system 220. As shown in FIG. 3, content searching system 220 may include a web content search unit 310, a custom content search unit 320, a duplicate content search unit 330, a database 340, and a security unit 350 interconnected via a bus and/or network 360 with network 240. Web content search unit 310, custom content search unit 320, duplicate content search unit 330, database 340, and security unit 350 may be implemented as software and/or hardware components within a single entity, or as software and/or hardware components distributed across multiple entities.

Web content search unit 310 may crawl documents (e.g., containing web content) stored at data server(s) 230, index the crawled documents to create a web search index, and search the crawled documents using the web search index. Custom content search unit 320 may obtain custom content, such as items of content uploaded from users, items of content designated by the users as being part of their custom content (e.g., a user may designate one or more documents (e.g., web sites or web pages) to be included in the user's custom content), items of content obtained from sources that require subscriptions for access to the content, and/or items of content on a given topic that may be obtained and aggregated from multiple sources (e.g., the user may designate one or more documents (e.g., web sites or web pages) that contain content about a selected topic as being included in the user's custom content), index the content in separate custom search indexes to create multiple different custom search indexes (also referred to herein as “custom content groups”), and search the custom content using one or more of the different custom search indexes.

Duplicate content search unit 330 may receive sample custom content from a custom content owner and perform a search of custom content previously obtained by custom content search unit 320 from other users, and associated with one or more custom content groups, to determine whether the sample custom content matches the custom content associated with one or more of the custom content groups. Duplicate content search unit 330 may inform the custom content owner of possible uses of the custom content owner's content by other users based, for example, on a result of the search.

Database 340 may store a web search index, one or more custom search indexes, and/or information regarding web content and/or custom content. Database 340 may store the web search index and the one or more custom search indexes as different data structures that may be searched independently of one another. Alternatively, database 340 may store one or more custom search indexes within the same data structure as the web search index in a manner that they may be searched independently of one another. Each of the custom search indexes may include multiple index entries, with each entry containing a term or other data stored in association with an item of custom content in which the term or other data appears, and a location within the custom content where the term or other data appears.

Database 340 may also store information associated with the web content obtained by web content search unit 310 and the custom content obtained by custom content search unit 320. The information may include text, image data, video data, and/or audio data this is associated with the web content and/or the custom content.

Security unit 350 may authenticate users desiring to upload custom content to custom content search unit 320, users desiring to search one or more custom content indexes associated with custom content, and/or users desiring to identify whether others are using their custom content without permission. Security unit 350 may authenticate users by passing authentication tokens to the users, and may contain security keys to permit encryption for sensitive information. Security unit 350 may authenticate users and authorize duplicate content search unit 330 to perform searches for the authenticated users.

Bus and/or network 360 may include a communication path, such as a system bus or a network that permits web content search unit 310, custom content search unit 320, duplicate content search unit 330, and security unit 350 to communicate with one another and with entities on network 240.

### Exemplary Web Content Search Unit

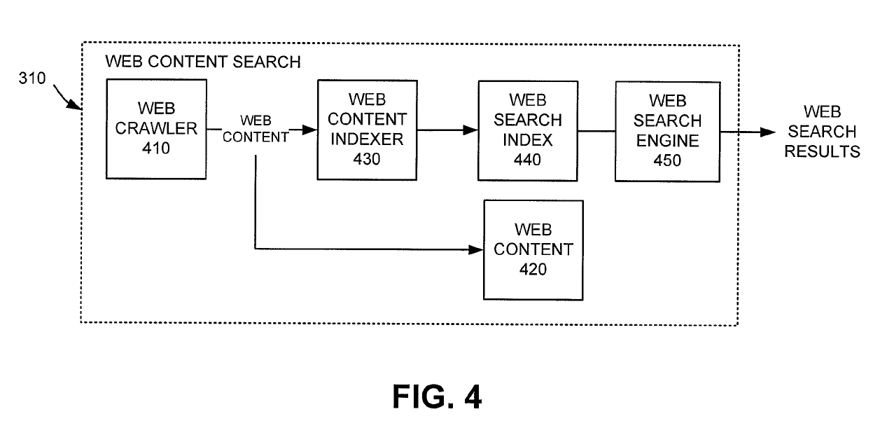

FIG. 4 is an exemplary diagram of web content search unit 310. As shown in FIG. 4, web content search unit 310 may include a web crawler 410, web content storage 420, web content indexer 430, web search index 440, and web search engine 450. Web crawler 410, web content storage 420, web content indexer 430, web search index 440, and web search engine 450 may be implemented as software and/or hardware components.

Web crawler 410 may find and retrieve web content (e.g., web documents) and provide the retrieved web content to web content storage 420 and web content indexer 430. For example, web crawler 410 may send a request to a web server for a web document, download the entire web document, and then provide the web document to web content storage 420 and web content indexer 430. Web content storage 420 may store information regarding the web documents, such as text, image data, video data, and/or audio data associated with the web documents or links to the text, image data, video data, and/or audio data.

Web content indexer 430 may index the web documents to create web search index 440. For example, web content indexer 430 may take the text or other data of a given crawled document, extract individual terms or other data from the text of the document, and sort those terms or other data (e.g., alphabetically) in web search index 440. For text, for example, web content indexer 430 may identify words that are unlikely to occur (e.g., occur less than a particular threshold number of times in a set of documents) as other data to be included in the index for the text.

Other techniques for extracting and indexing content, that are more complex than simple word-level indexing, may also be used, including techniques for indexing XML data, image data, video data, audio data, etc. For image data, web content indexer 430 may identify one or more image features (e.g., one or more dominant colors of an image) as other data to be included in the index for the image data. For video data, web content indexer 430 may identify one or more video features (e.g., one or more dominant colors of frames of the video data, or one or more frequencies of the audio portion of the video data that do no regularly occur) as other data to be included in the index for the video data. For audio data, web content indexer 430 may identify one or more audio features (e.g., one or more frequencies that do not regularly occur) as other data to be included in the index for the audio data. Each entry in web search index 440 may contain a term or other data stored in association with a list of documents in which the term or other data appears and the location within the document where the term or other data appears.

Web search engine 450 may search web search index 440, based on a received search query, to match terms of the search query with terms or other data (e.g., video data, image data, audio data, etc.) contained in entries in web search index 440. Web search engine 450 may retrieve a corresponding list of documents from each entry in web search index 440 that matches a term of the search query. The lists of documents retrieved from one or more entries in web search index 440 may be returned as web search results. In one implementation, each result of the web search results may include a uniform resource locator (URL) associated with a corresponding search result document and, possibly, a snippet of content extracted from the corresponding search result document.

### Exemplary Custom Content Search Unit

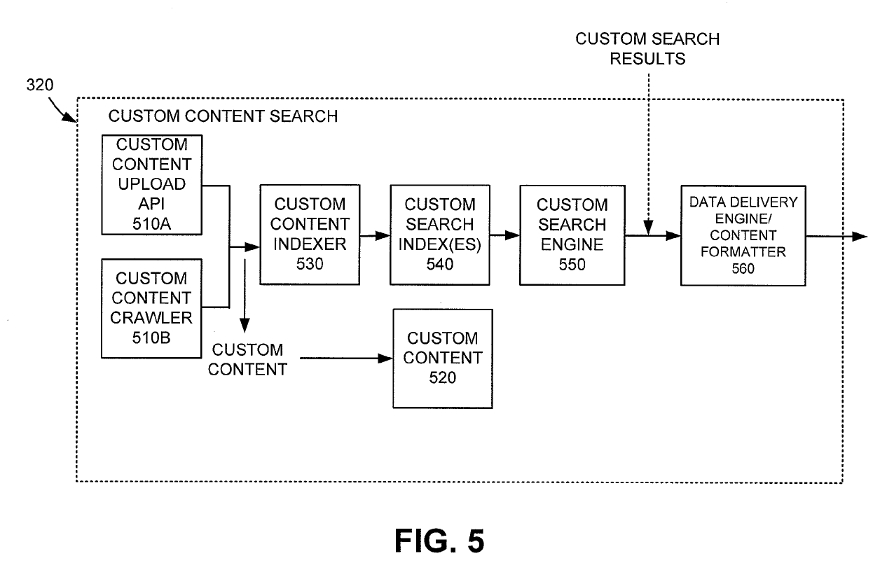

FIG. 5 is an exemplary diagram of custom content search unit 320. As shown in FIG. 5, custom content search unit 320 may include a custom content upload Application Programmer Interface (API) 510A, a custom content crawler 510B, custom content storage 520, a custom content indexer 530, one or more custom search indexes 540, a custom search engine 550, and a data delivery engine/content formatter 560. Custom content upload API 510A, custom content crawler 510B, custom content storage 520, custom content indexer 530, one or more custom search indexes 540, custom search engine 550, and data delivery engine/content formatter 560 may be implemented as software and/or hardware components.

Custom content upload API 510A may receive custom content uploaded from one or more users (e.g., one or more authenticated users). The uploaded content may include data of any type or format. In one implementation, the uploaded content may include meta-data (e.g., XML data). The meta-data may include content meta-data with pointers to actual content. In another implementation, custom content upload API 510A may include a translation engine for translating any type or format of uploaded data into a particular type or format of data that can be more easily processed by custom content indexer 530. Custom content upload API 510A may pass the received custom content to custom content storage 520 and custom content indexer 530.

Custom content crawler 510B may crawl specific content on the web or within one or more databases to retrieve documents that may be indexed in a corresponding custom search index 540. For example, custom content crawler 510B may crawl available documents on the web containing content directed to a specific topic (e.g., dogs, football, etc.) or documents identified by a user (e.g., the “owner” of a corpus of custom content). As an additional example, custom content crawler 510B may crawl documents similar to documents identified by the user as being part of the user's custom content. The user may, thus, designate content that may be grouped together and searched via the user's custom search index. Custom content crawler 510B may, in some implementations, need to be authenticated by content providers associated with specific custom content crawled on the web or within one or more databases. Custom content crawler 510B may pass the crawled custom content to custom content storage 520 and custom content indexer 530.

Custom content storage 520 may store information regarding the custom content, such as text, image data, video data, and/or audio data associated with the custom content or links to the text, image data, video data, and/or audio data. Custom content indexer 530 may index custom content to create custom search index(es) 540. For example, custom content indexer 530 may take the text or other data of custom content, extract individual terms from the text or other data, and sort those terms or other data (e.g., alphabetically) into a single custom search index 540. For text, custom content indexer 530 may identify words that are unlikely to occur (e.g., occur less than a particular threshold number of times in a set of documents) as other data to be included in the index for the text.

Other techniques for extracting and indexing content, that are more complex than simple word-level indexing, may also be used, including techniques for indexing XML data, image data, video data, audio data, etc. For image data, custom content indexer 530 may identify one or more image features (e.g., one or more dominant colors of an image) as other data to be included in the index for the image data. For video data, custom content indexer 530 may identify one or more video features (e.g., one or more dominant colors of frames of the video data, or one or more frequencies of the audio portion of the video data that do no regularly occur) as other data to be included in the index for the video data. For audio data, custom content indexer 530 may identify one or more audio features (e.g., one or more frequencies that do not regularly occur) as other data to be included in the index for the audio data. Each entry in a custom search index 540 may contain a term or other data stored in association with an item of content in which the term or other data appears and a location within the custom content where the term or other data appears.

Custom search engine 550 may search custom search index(es) 540, based on a received search query, to match terms of the search query with terms or other data contained in entries in custom search index(es) 540. If custom search index(es) 540 includes multiple different custom search indexes, then custom search engine 550 may search, based on the received search query and, possibly, user authentication, selected ones of the different custom search indexes. Custom search engine 550 may retrieve a corresponding list of items of custom content from each entry in custom search index 540 that matches a term of the search query. The lists of items of content retrieved from one or more entries in custom search index 540 may be returned as custom search results 540. In one implementation, each result of custom search results 540 may include a URL associated with a corresponding search result document and, possibly, a snippet of content extracted from the corresponding search result document.

Data delivery engine/content formatter 560 may receive the search results from custom search engine 550, format the search results into a meaningful data format (e.g., into an HTML document) that can be received and displayed by the user (e.g., via a web browser). Data deliver engine/content formatter 560 may customize the formatting of the search results (e.g., the content and visual format of the data) received from custom search engine 550 based on individual user preferences or based on the preferences of the custom content owner whose custom content is being searched.

### Exemplary Database

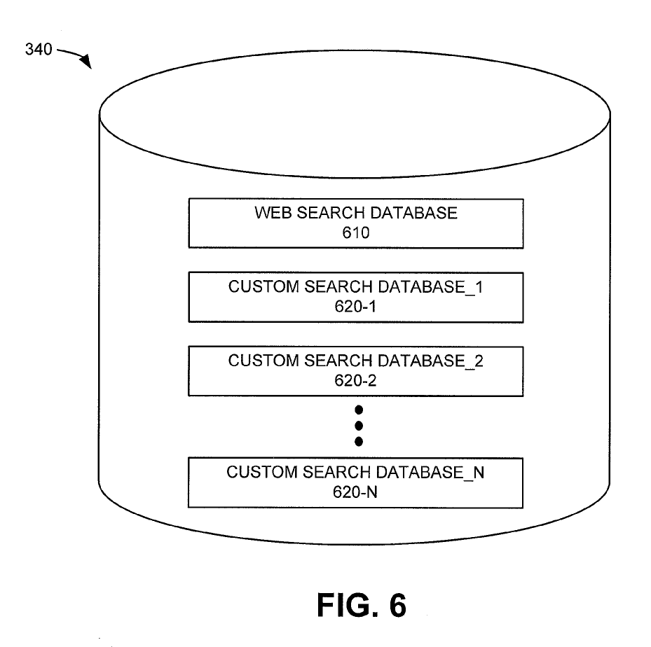

FIG. 6 is an exemplary diagram of database 340. In practice, database 340 may be included in a single memory device or multiple, different memory devices. As shown in FIG. 6, database 340 may include a web search database 610 and one or more custom search databases 620-1 through 620-N (wherein N≧1) (collectively referred to as “custom search databases 620”). In one implementation, custom search databases 620 may include data structures that are different from one another, and from web search database 610. Web search database 610 may include web content storage 420 and/or web search index 440. Custom search databases 620 may include custom content storage 520 and/or custom search index(es) 540.

Duplicate content search unit 330 may search web search database 610 and/or custom search databases 620 to determine whether sample content matches items of content in web search database 610 and/or custom search databases 620. In making this determination, duplicate content search unit 330 may perform a search of web content storage 420, web search index 440, custom content storage 520, and/or custom search index(es) 540. Duplicate content search unit 330 may perform the search such that it is transparent to a searching user who initiated the search and without exposing detailed search results to the searching user. In this manner, duplicate content search unit 330 may maintain the privacy of the information in the custom content groups. In one implementation, duplicate content search unit 330 may simply inform the searching user whether there is a match and possibly the identity of the custom content group in which the match was found.

### Exemplary Duplicate Content Search Unit

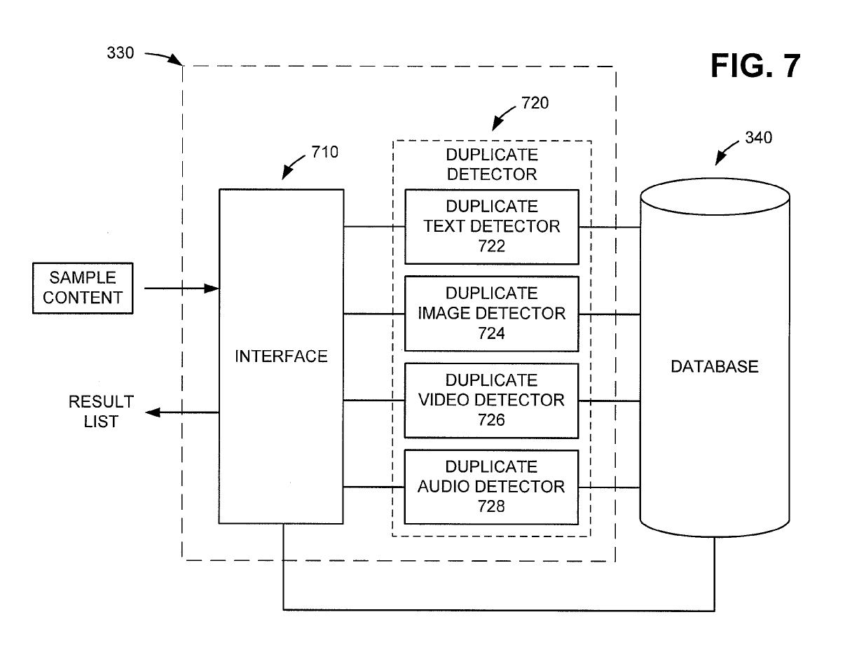

FIG. 7 is an exemplary diagram of duplicate content search unit 330. As shown in FIG. 7, duplicate content search unit 330 may include an interface 710 and a duplicate detector 720 connected to database 340. Interface 710 and duplicate detector 720 may be implemented as software and/or hardware components.

Interface 710 may present a user interface to a user via which the user can provide sample content and receive a result. In one implementation, interface 710 may present a user interface that is accessible via network 240. For example, the user may use a web browser implemented on a client 210 to access the user interface presented by interface 710.

Interface 710 may receive the sample content from the user and perform an initial analysis on the sample content to identify the type of content that the user provided. For example, the user might provide content in the form of text, image data, video data, or audio data. In one implementation, interface 710 may determine whether the type of the content is a type of content supported by duplicate content search unit 330.

Interface 710 may also determine, for example, whether the user provided at least a threshold amount of content. The threshold amount of content may be determined as a minimum amount of content that is needed to find a match to a particular degree of accuracy in database 340. The threshold may differ for different types of content. For example, the threshold for content in text form may be set as one or two paragraphs; the threshold for content in image form may be set as the entire image; the threshold for content in video form may be set as more than X seconds (or minutes) of the video; or the threshold for content in audio form may be set as more than Y seconds (or minutes) of the audio. Interface 710 may notify the user if less than the threshold amount of content is received.

Interface 710 may also perform some initial processing on the sample content to facilitate the processing performed by duplicate detector 720. For example, interface 710 may determine particular terms or features from the sample content and search indexes 440 and/or 540 to identify items of content that have these same terms or features. Interface 710 may provide information regarding the identified items of content to duplicate detector 720. In this way, interface 710 may reduce the number items of content to be processed by duplicate detector 720.

Duplicate detector 720 may perform a search of database 340 based on the sample content received by interface 710. In one implementation, duplicate detector 720 may include duplicate text detector 722, duplicate image detector 724, duplicate video detector 726, and/or duplicate audio detector 728.

Duplicate text detector 722 may include software and/or hardware that can determine, given sample text, whether the sample text matches text associated with content in web search database 610 and/or custom search database(s) 620. Duplicate text detector 722 may generate a confidence score for each document in web search database 610 and/or custom search database(s) 620 that indicates how near a match the sample text is to text in the documents. Duplicate text detector 722 may return information regarding documents with confidence scores above a certain threshold to interface 710. This information may include information regarding the custom content groups with which the documents are associated and/or the addresses (e.g., URLs) of the documents.

There are various techniques that duplicate text detector 722 may use to identify a match. In one implementation, duplicate text detector 722 may use a shingling technique. The shingling technique takes sets of contiguous terms (i.e., shingles), performs a hash on the shingles, and compares the number of matching shingles. By comparing the shingles, duplicate text detector 722 may determine a percentage of overlap between two sets of text. Duplicate text detector 722 may generate a confidence score based on the amount of overlap between the shingles of the two sets of text.

In another implementation, duplicate text detector 722 may use a similarity detection technique. The similarity detection technique may consider a set of text as a vector of terms. For example, a vector may be created for each group of terms (e.g., sentence) in the set of text. The vector may include an entry for each unique term in the group. The similarity detection technique may generate a confidence score based on the number of the vectors that match between the two sets of text.

In yet another implementation, duplicate text detector 722 may use a different technique, or a combination of techniques, to identify a match between two sets of text. For example, duplicate text detector 722 may perform a search on web search index 440 and/or custom search index(es) 540 to identify documents that contain at least a threshold number of terms of the sample text. Duplicate text detector 722 may then perform a text-matching technique to determine a confidence score that indicates how near a match the sample text is to text in the identified documents.

Duplicate image detector 724 may include software and/or hardware that can determine, given a sample image, whether the sample image matches an image associated with content in web search database 610 and/or custom search database(s) 620. Duplicate image detector 724 may generate a confidence score for each document in web search database 610 and/or custom search database(s) 620 that indicates how near a match the sample image is to an image in the documents. Duplicate image detector 724 may return information regarding documents with confidence scores above a certain threshold to interface 710. This information may include information regarding the custom content groups with which the documents are associated and/or the addresses (e.g., URLs) of the documents.

There are various techniques that duplicate image detector 724 may use to identify a match. In one implementation, duplicate image detector 724 may use a technique that compares features of images. A number of different possible image features may be used. Examples of image features that may be used include image features based on, for example, intensity, color, edges, texture, wavelet based techniques, or other aspects of the image.

Regarding intensity, for example, each image may be divided into small patches (e.g., rectangles, circles, etc.) and an intensity histogram computed for each patch. Each intensity histogram may be considered to be a feature for the image. Similarly, as an example of a color-based feature, a color histogram may be computed for each patch (or for different patches) within each image. A color histogram can be similarly computed to obtain a possible color-based histogram. The color histogram may be calculated using any known color space, such as the RGB (red, green, blue) color space, YIQ (luma (Y) and chrominance (IQ)), or another color space.

Histograms can also be used to represent edge and texture information. For example, histograms can be computed based on patches of edge information or texture information in an image. For wavelet based techniques, a wavelet transform may be computed for each patch and used as an image feature.

In some implementations, to improve computation efficiency, features may be computed only for certain areas within images. For example, “objects of interest” within an image may be determined and image features may only be computed for the objects of interest. For example, if the image feature being used is a color histogram, a histogram may be computed for each patch in the image that includes an object of interest. Objects of interest within an image can be determined in a number of ways. For example, for color, objects of interest may be defined as points where there is high variation in color (i.e., areas where color changes significantly). In general, objects of interest can be determined mathematically in a variety of ways and are frequently based on determining discontinuities or differences from surrounding points. The Scale-Invariant Feature Transform (SIFT) algorithm is an example of one technique for locating objects of interest.

Additionally, in some implementations, the various features described above may be computed using different image scales. For example, an image can be examined and features computed in its original scale and then features may be successively examined at smaller scales. Additionally or alternatively, features may be selected as features that are scale invariant or invariant to affine transformations. The SIFT technique, for example, can be used to extract distinctive invariant objects from images. The extracted objects are invariant to image scale and rotation.

For each feature that is to be used, a comparison function may be used. In general, a comparison function may operate to generate a confidence score defining a similarity between a particular feature computed for two images. For image features based on histograms, for example, the comparison function may include a simple histogram comparer function. For image features other than those based on histograms, a different comparison function may be used.

In another implementation, duplicate image detector 724 may use another technique, or a combination of techniques, to determine whether two images match. For example, duplicate image detector 724 may use a hash-based technique, a byte-by-byte comparison technique, or a cyclic redundancy check (CRC) technique. Additionally, or alternatively, duplicate image detector 724 may compare tag information (e.g., labels or other meta-data assigned to the images) to determine whether two images match.

Duplicate video detector 726 may include software and/or hardware that can determine, given a sample video, whether the sample video matches a video associated with content in web search database 610 and/or custom search database(s) 620. Duplicate video detector 726 may generate a confidence score for each document in web search database 610 and/or custom search database(s) 620 that indicates how near a match the sample video is to a video in the documents (e.g., a document may include a link for playing or downloading the video or provide a player via which the video can be played). Duplicate video detector 726 may return information regarding documents with confidence scores above a certain threshold to interface 710. This information may include information regarding the custom content groups with which the documents are associated and/or the network addresses (e.g., URLs) of the documents.

There are various techniques that duplicate video detector 726 may use to identify a match. In one implementation, duplicate video detector 726 may divide videos into frames and uses a technique similar to a technique used by duplicate image detector 724 to identify matches in the frames of two videos. Duplicate video detector 726 may generate a confidence score that is based on the number of frames that match between two videos.

In another implementation, duplicate video detector 726 may use a technique that compares text data, such as closed captioning text or a speech transcription, associated with two videos to determine whether the videos match. In this case, duplicate video detector 726 may use a technique similar to a technique used by duplicate text detector 722. In yet another implementation, duplicate video detector 726 may divide the videos in short clips and produce spatio-temporal descriptors that are used to identify matching videos. This technique is described in further detail in D. DeMenthon, “Video Retrieval of Near-Duplicates Using K-Nearest Neighbor Retrieval of Spatio-Temporal Descriptors,” Language and Media Processing (LAMP), University of Maryland Institute for Advanced Computer Studies (UMIACS), 2006.

In yet another implementation, duplicate video detector 726 may use another technique, or a combination of techniques, to determine whether two videos match. For example, duplicate video detector 726 may use a hash-based technique, a byte-by-byte comparison technique, or a cyclic redundancy check (CRC) technique. Additionally, or alternatively, duplicate video detector 726 may compare tag information (e.g., labels or other meta-data assigned to the videos) to determine whether two videos match.

Duplicate audio detector 728 may include software and/or hardware that can determine, given sample audio, whether the sample audio matches audio associated with content in web search database 610 and/or custom search database(s) 620. Duplicate audio detector 728 may generate a confidence score for each document in web search database 610 and/or custom search database(s) 620 that indicates how near a match the sample audio is to audio in the documents (e.g., a document may include a link for playing or downloading the audio or provide a player via which the audio can be played). Duplicate audio detector 728 may return information regarding documents with confidence scores above a certain threshold to interface 710. This information may include information regarding the custom content groups with which the documents are associated and/or the network addresses (e.g., URLs) of the documents.

There are various techniques that duplicate audio detector 728 may use to identify a match. In one implementation, duplicate audio detector 728 may use an audio fingerprinting technique. The audio fingerprinting technique may generate a fingerprint for segments of the audio and compare these segments to audio associated with content in web search database 610 and/or custom search database(s) 620. By comparing the segments, duplicate audio detector 728 may determine a percentage of overlap between two sets of audio. Duplicate audio detector 728 may generate a confidence score based on the amount of overlap between the segments of the two sets of audio.

In another implementation, duplicate audio detector 728 may use a technique that compares text data, such as a speech transcription, associated with two sets of audio to determine whether the two sets of audio match. In this case, duplicate audio detector 728 may use a technique similar to a technique used by duplicate text detector 722.

In yet another implementation, duplicate audio detector 728 may use another technique, or a combination of techniques, to determine whether two sets of audio match. For example, duplicate audio detector 728 may use a hash-based technique, a byte-by-byte comparison technique, or a cyclic redundancy check (CRC) technique. Additionally, or alternatively, duplicate audio detector 728 may use tag information (e.g., labels or other meta-data assigned to the audio data) to determine whether two sets of audio match.

### Exemplary Duplicate Content Searching Process

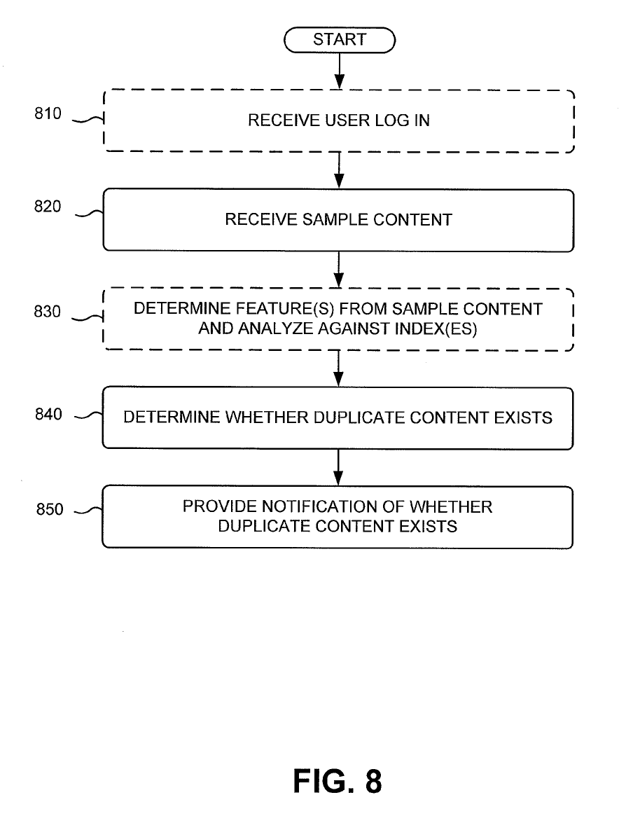

FIG. 8 is a flowchart of an exemplary process for providing information regarding the unauthorized use of content. The process exemplified by FIG. 8 may be performed by duplicate content search unit 330 either alone or in combination with another component of content searching system 220.

The exemplary process may begin when a user (hereinafter “custom content owner”) expresses a desire to determine whether anyone is using the custom content owner's content without the custom content owner's permission. In one implementation, the custom content owner may use a browser on client 210 to access interface 710 provided by duplicate content search unit 330. For example, the custom content owner may enter a network address (e.g., a URL) associated with duplicate content search unit 330 into the browser.

A user log in may be received (block 810). In one implementation, the custom content owner may need to log into duplicate content search unit 330 or content searching system 220 to perform a search. For example, duplicate content search unit 330 may permit only authorized users (e.g., users who are owners of a custom content group) to perform a search. To authenticate the custom content owner, when necessary, content searching system 220 may present the custom content owner with a user interface for providing log-in information, such as a custom content log-in (e.g., username) and custom content password. Content searching system 220 may maintain a set of usernames, passwords, and information regarding the custom content groups for which the users are also owners. When a custom content owner provides a custom content log-in and a custom content password for a particular custom content group, content searching system 220 may verify that the information that the custom content owner provided matches the information that it maintains.

In another implementation, authentication of the custom content owner may have occurred at some prior point in time. For example, a custom content owner may have logged into content searching system 220 for some other reason (e.g., to perform a search during a prior search session, to check e-mail, to access an online calendar, to access an instant messenger, or for some other service offered by content searching system 220). In this case, user authentication may not need to occur again.

Sample content may be received (block 820). For example, the custom content owner may upload a portion or all of the text, image data, video data, and/or audio data (“sample content”) that the custom content owner desires to verify that no one is using without the custom content owner's permission. Duplicate content search unit 330, or content searching system 220, may provide a mechanism to facilitate the custom content owner's uploading of the content.

In one exemplary implementation, one or more features may be determined from the sample content and these one or more features may be analyzed against one or more of index(es) 440 and/or 450 (block 830). For example, interface 710 may determine one or more terms from the sample content when the sample content is text, one or more image features from the sample content when the sample content is image data, one or more video features, image features, and/or audio features from the sample content when the sample content is video data, or one or more audio features from the sample content when the sample content is audio data. Interface 710 may then perform a search of one or more of index(es) 440 and/or 450 to identify items of content that have matching features. Thus, interface 710 may reduce the number of items of content to a subset of database 340 that needs to be processed.

It may be determined whether duplicate content exists (block 840). For example, duplicate content search unit 330 may identify what type of content was received from the custom content owner. Duplicate content search unit 330 may then instruct the appropriate duplicate content detector (e.g., duplicate text detector 722, duplicate image detector 724, duplicate video detector 726, or duplicate audio detector 728) to search database 340 (or a subset of database 340) to determine whether any of the content matches the sample content received from the custom content owner. For each item of content that matches the sample content, duplicate content search unit 330 may identify the item of content (e.g., by network address) and/or the custom content group in which the item of content belongs.

In an alternative implementation, duplicate content search unit 330 may cause a duplicate content detector (duplicate text detector 722, duplicate image detector 724, duplicate video detector 726, or duplicate audio detector 728) of a different type than the sample content to process the sample content. For example, when the sample content takes the form of sample video, duplicate video detector 726 may determine whether the sample video matches items of video content in database 340 (or a subset of database 340), duplicate image detector 724 may determine whether one or more frames of the sample video matches items of image content in database 340 (or a subset of database 340), and/or duplicate audio detector 728 may determine whether audio associated with the sample video (e.g., sound track, music track, etc.) matches items of audio content in database 340 (or a subset of database 340). Duplicate content search unit 330 may permit the custom content owner to specify which type of duplicate detection the custom content owner desires.

A notification of whether duplicate content exists may be provided (block 850). In one implementation, the notification may take the form of a simple response that duplicate content either exists or it does not exist. In this case, duplicate content search unit 330 may also provide the custom content owner with an identifier that the custom content owner can use to trigger an investigation by a human investigator (e.g., someone affiliated with content searching system 220). The identifier may encrypt information regarding the network address associated with the matching content and/or the custom content group containing the matching content to assist the human investor in finding the matching content. In another implementation, the notification may take the form of a list of custom content groups that have items of content that match the custom content owner's content. In this case, the custom content owner may use this information to trigger an investigation by a human investigator. In yet another implementation, the notification may take a different form. In any case, the search and the search results may be transparent to the custom content owner to maintain the privacy of information in the custom content groups.

As an additional privacy measure, in an alternative implementation, content searching system 220 may export a hash function (e.g., a one-way hash function) that would permit the custom content owner to hash the sample content and transmit the resulting hash value(s) to content searching system 220 for duplicate detection. Content searching system 220 may use a similar hashing function on content in its database and detect duplicates by comparing the hash values. In this way, the custom content owner can identify potential duplicate content without exposing the sample content to content searching system 220.

### EXAMPLE

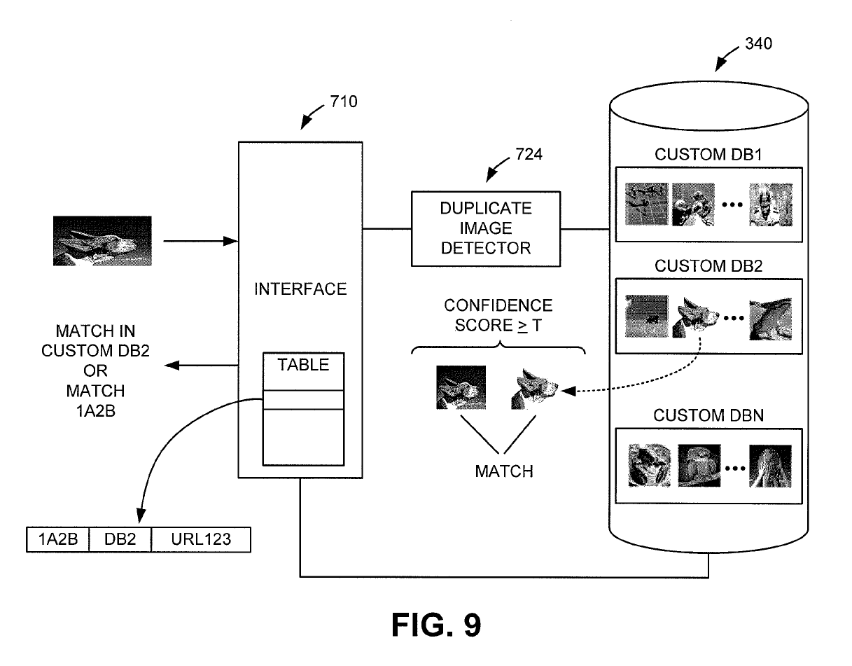

FIG. 9 is a diagram of an example for providing information regarding the unauthorized use of content. Assume that a content owner contacts duplicate content search unit 330 to determine whether anyone else is using the content owner's content without the content owner's permission. There may be different reasons why the custom content owner would be interested in discovering unauthorized use of the custom content owner's content.

One reason may be that the content may include intellectual property of the custom content owner. For example, the custom content owner may hold a copyright or trademark on the content and, thus, may not want others infringing upon the content owner's intellectual property rights. Another reason may be that some custom content groups may include private content that may be available to only select users. Thus, a custom content owner may want to make sure that no one else is using the custom content owner's private content. A further reason may be that some custom content groups may require users to subscribe to their custom content groups and may require payment of a subscription fee. As a result, a custom content owner may not want someone else to financially gain from use of the content owner's content. The foregoing are simply examples of reasons why a custom content owner might want to discover whether someone else is using the custom content owner's content.

As shown in FIG. 9, assume that the content owner wants to know whether anyone else is using one of the content owner's images without the content owner's permission. The content owner may contact content search system 220 and interact with interface 710 of duplicate content search unit 330 to upload a sample image (i.e., a picture of a dog). Interface 710 may provide the sample image to duplicate image detector 724. Duplicate image detector 724 may process the sample image based, for example, on the features of the sample image, as described above.

Duplicate image detector 724 may perform a search of database 340 (or a subset of database 340) to determine whether any of the images contained in the custom search databases 620 (e.g., custom database 1 (DB1), . . . , custom database N (DBN)), for example, matches the sample image. For example, duplicate image detector 724 may compare the sample image to each of the images in custom search databases 620 (or a subset of custom search databases 620) using one of the techniques described above. Duplicate image detector 724 may determine a confidence score for each of the images in the custom search databases 620 (or a subset of custom search databases 620) based on a result of the comparison. Duplicate image detector 724 may determine that there is a match when the confidence score is greater than or equal to T (where T is a particular threshold). For any matching image, duplicate image detector 724 may provide information regarding where the image was found to interface 710. In one implementation, this information may include the name of the custom content group associated with the custom database in which the image was identified and/or the network address (e.g., URL) of the document containing the image.

As shown in FIG. 9, assume that duplicate image detector 724 finds a match in DB2. In this case, duplicate image detector 724 may inform interface 710 that a match was found in DB2. Interface 710 may inform the custom content owner that a match was found in DB2. Alternatively, or additionally, interface 710 may inform custom content owner that there was a match and may provide the custom content owner with an identifier (i.e., 1A2B) that the customer content owner can use to initiate an investigation. In this case, interface 710 may contain a table that maps the identifier (i.e., 1A2B) to the network address (i.e., URL123) of the document containing the matching image and/or the custom content group (i.e., DB2) containing the document.

The custom content owner may contact a human investigator to investigate and/or confirm that the custom content owner's image is being used without the custom content owner's permission. For example, the human investigator may verify the match and take appropriate action, such as causing the image to be removed from DB2.

### CONCLUSION

Implementations described herein provide illustration and description, but is not intended to be exhaustive or to limit these implementations to the precise form disclosed. Modifications and variations are possible in light of the above teachings, or may be acquired from practice of these implementations. For example, while a series of blocks has been described with regard to FIG. 8, the order of the blocks may be modified in other implementations. Further, non-dependent blocks may be performed in parallel.

It will be apparent that aspects described herein may be implemented in many different forms of software, firmware, and hardware in the implementations illustrated in the figures. The actual software code or specialized control hardware used to implement these aspects is not limiting of the invention. Thus, the operation and behavior of the aspects have been described without reference to the specific software code, it being understood that software and control hardware could be designed to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A system, comprising:
a database to store information regarding items of content uploaded or identified by a plurality of first users; and
a duplicate content search unit to:
receive sample content from a second user,
determine whether the sample content matches one or more of the items of content, and
notify the second user whether the sample content matches one or more of the items of content without identifying the one or more items of content to the second user.

2. The system of claim 1, wherein the sample content includes sample text; and
wherein when determining whether the sample content matches one or more of the items of content, the duplicate content search unit is configured to determine whether the sample text matches text of one or more of the items of content.

3. The system of claim 1, wherein the sample content includes sample image data; and
wherein when determining whether the sample content matches one or more of the items of content, the duplicate content search unit is configured to determine whether the sample image data matches image data of one or more of the items of content.

4. The system of claim 1, wherein the sample content includes sample video data;
wherein when determining whether the sample content matches one or more of the items of content, the duplicate content search unit is configured to determine whether the sample video data matches video data of one or more of the items of content.

5. The system of claim 1, wherein the sample content includes sample audio data; and
wherein when determining whether the sample content matches one or more of the items of content, the duplicate content search unit is configured to determine whether the sample audio data matches audio data of one or more of the items of content.

6. The system of claim 1, wherein the duplicate content search unit is further configured to determine whether the sample content includes text, image data, video data, or audio data.

7. The system of claim 6, wherein the duplicate content search unit is further configured to determine whether at least a threshold amount of the sample content is received.

8. The system of claim 7, wherein the threshold amount differs depending on whether the sample content includes text, image data, video data, or audio data.

9. The system of claim 1, wherein when determining whether the sample content matches one or more of the items of content, the duplicate content search unit is configured to:
search the database based on the sample content,
generate a confidence score for each of a plurality of the items of content that indicates a measure of how near a match the item of content is to the sample content, and
identify whether one of the plurality of items of content has the confidence score above a threshold.

10. The system of claim 9, wherein when notifying the second user, the duplicate content search unit is configured to:
inform the second user that there is a match when the one of the plurality of items of content has the confidence score above the threshold.

11. The system of claim 1, wherein when notifying the second user, the duplicate content search unit is configured to:
send, to the second user, an identifier that encrypts at least one of a network address associated with one of the one or more items of content or a content group with which the one of the one or more items of content belongs.

12. The system of claim 11, wherein the duplicate content search unit includes:
a table to store a mapping from the identifier to the at least one of the network address associated with the one of the one or more items of content or the content group with which the one of the one or more items of content belongs.

13. The system of claim 1, further comprising:
an index that stores one or more first features relating to the items of content; and
wherein the duplicate content search unit is further configured to:
determine one or more second features relating to the sample content,
search the index to identify a subset of the items of content that have at least one of the one or more first features that match the one or more second features.

14. The system of claim 13, wherein when determining whether the sample content matches one or more of the items of content, the duplicate content search unit is configured to determine whether the sample content matches one or more of the items of content in the subset of the items of content.

15. The system of claim 1, wherein the sample content received from the second user includes hashed content; and
when determining whether the sample content matches one or more of the items of content, the duplicate content search unit is configured to compare the hashed content to hashes associated with the items of content.

16. A system, comprising:
means for storing information regarding a plurality of items of content;
means for receiving sample content from a user;
means for determining whether the sample content matches one or more of the items of content; and
means for notifying the user whether the sample content matches one or more of the items of content without identifying the one or more items of content to the user.

17. A method, comprising:
storing information regarding items of content uploaded or identified by a plurality of first users;
receiving sample content from a second user;
determining whether at least a threshold amount of the sample content is received;
determining whether the sample content matches one or more of the items of content when at least the threshold amount of the sample content is received; and
notifying the second user whether the sample content matches one or more of the items of content.

18. The method of claim 17, wherein the sample content includes sample text; and
wherein determining whether the sample content matches one or more of the items of content includes determining whether the sample text matches text of one or more of the items of content.

19. The method of claim 17, wherein the sample content includes sample image data; and
wherein determining whether the sample content matches one or more of the items of content includes determining whether the sample image data matches image data of one or more of the items of content.

20. The method of claim 17, wherein the sample content includes sample video data; and
wherein determining whether the sample content matches one or more of the items of content includes determining whether the sample video data matches video data of one or more of the items of content.

21. The method of claim 17, wherein the sample content includes sample audio data; and
wherein determining whether the sample content matches one or more of the items of content includes determining whether the sample audio data matches audio data of one or more of the items of content.

22. The method of claim 17, further comprising determining whether the sample content includes text, image data, video data, or audio data.

23. The method of claim 22, wherein the threshold amount differs depending on whether the sample content includes text, image data, video data, or audio data.

24. The method of claim 17, wherein determining whether the sample content matches one or more of the items of content includes:
searching a database based on the sample content,
generating a confidence score for each of a plurality of the items of content that indicates a measure of how near a match the item of content is to the sample content, and
identifying whether one of the plurality of items of content has the confidence score above a threshold.

25. The method of claim 24, wherein notifying the second user includes informing the second user that there is a match when the one of the plurality of items of content has the confidence score above the threshold.

26. The method of claim 17, wherein notifying the second user includes sending, to the second user, an identifier that encrypts at least one of a network address associated with one of the one or more items of content or a content group with which the one of the one or more items of content belongs.

27. The method of claim 26, further comprising storing a mapping from the identifier to the at least one of the network address associated with the one of the one or more items of content or the content group with which the one of the one or more items of content belongs.

28. The method of claim 17, further comprising:
creating an index that stores one or more first features relating to the items of content;
determining one or more second features relating to the sample content; and
searching the index to identify a subset of the items of content that have one of the one or more first features that match the one or more second features.

29. The method of claim 28, wherein determining whether the sample content matches one or more of the items of content includes determining whether the sample content matches one or more of the items of content in the subset of the items of content.

30. A system, comprising:
a database to store information regarding items of content; and
a duplicate content search unit that includes:
an interface to:
receive sample content from a user, and
determine whether the sample content includes text, image data, video data, or audio data, and
at least two of:
a duplicate text detector to determine whether the sample content matches text of one or more of the items of content when the sample content includes text,
a duplicate image detector to determine whether the sample content matches image data of one or more of the items of content when the sample content includes image data,
a duplicate video detector to determine whether the sample content matches video of one or more of the items of content when the sample content includes video data, and
a duplicate audio detector to determine whether the sample content matches audio data of one or more of the items of content when the sample content includes audio data;
where the interface is further configured to notify the user whether the sample content matches the text, the image data, the video data, or the audio data of the one or more of the items of content.
